(19) United States
(12) Patent Application Publication
(10) Pub. No.: US 2014/0115891 A1
(43) Pub. Date: May 1, 2014

(54) CONNECTOR TERMINAL PREPARATION METHOD

(71) Applicant: Po-Kai HSU, New Taipei City (TW)

(72) Inventor: Po-Kai HSU, New Taipei City (TW)

(21) Appl. No.: 13/660,797

(22) Filed: Oct. 25, 2012

(51) Int. Cl. H01R 43/16

(52) U.S. Cl. 29/874

(57) ABSTRACT

A connector terminal preparation method includes the step of preparing a metal socket having a base and a cylindrical body extended from the base and then making a through hole on the base in communication with the inside of the cylindrical body and then electroplating a metal coating layer on the inner and outer surfaces of the base and cylindrical body of the metal socket, and the step of employing a mechanical processing process to deform the base of the metal socket and to have the through hole of the metal socket be fully enclosed.

### BACKGROUND OF THE INVENTION

1. Field of the Invention

The present invention relates to electrical signal connectors and more particularly to a connector terminal preparation method, which enhances the conductivity, heat resistance and anti-wear and anti-rust properties of the component parts thus made so that the finished connector terminal can provide a high level of signal transmission efficiency and stability.

2. Description of the Related Art

With the rapid development of electronic technology and multimedia revolution, cell phone, smart phone, GPS navigation device, PDA and many other mobile electronics are created and widely used in different fields. It is now the market tendency to create mobile devices having light, thin, short and small characteristics. In consequence, electronic components for installation in a circuit board for mobile device must be made smaller, more precise and stronger than ever before.

Further, electrical connectors are intensively used to connect electronic devices to a circuit board. An electrical connector generally comprises a plurality of signal connector terminals and power connector terminals connected with respective conductors of a cable for transmitting signal or power supply to a control circuit. As electrical connectors get ever smaller, many new types of electrical connectors are created. For example, a pogo pin connector is a spring loaded connector used in an electronic device to establish a connection between two printed circuit boards. A pogo pin generally comprises a metal socket (cylinder), a probe head mounted in the metal socket, and a spring mounted inside the metal socket to support the probe head. When the probe head is forced toward the inside of the metal socket by an external pressure, the spring can be elastically deformed. Subject to contact between the probe head and the inside wall of the metal socket, the pogo pin achieves electrical connection between two printed circuit boards. For the advantages of small size, large current, strong contact point, high durability and connection stability, pogo pin connectors are widely used in cell phone battery, antenna connector, GPS navigation device, tablet computer, handheld computer, wireless receiver or wireless communication device for conducting electric current or transmitting signals.

Further, when the probe head of a pogo pin is forced toward the inside of the metal socket to compress the spring, the elastic potential energy of the spring forces the probe head to stop against a part of the inside wall of the metal socket, achieving electric connection. To ensure connection stability, the inner and outer surface of a metal socket for pogo pin will be electroplated with a metal coating layer to enhance conductivity and to provide a better bonding surface. During electroplating, metal ions in a solution are moved by an electric field to coat an electrode. The process uses electrical current to reduce cations of a desired material from a solution and coat a conductive object with a thin layer of the material.

However, as the metal socket of a pogo pin is a blind hole structure, gases (hydrogen and etc.) released during electroplating may be accumulated in the blind hole of the metal socket, causing cracks in the metal coating layer, or affecting even distribution of electric current to lower the speed of the deposition of metal ions on the surface of the metal socket. Due to low current efficiency (the ratio of the amount of electricity, in coulombs, theoretically required to yield a given quantity of material in an electrochemical process, to the amount actually consumed), it takes much electroplating time to reach the desired coating thickness. Because of slow deposition rate, it is difficult to coat the desired metal coating layer on the inner surface of the metal socket. In consequence, the manufacturing cost of the metal socket is high.

### SUMMARY OF THE INVENTION

The present invention has been accomplished under the circumstances in view. It is therefore the main object of the present invention to provide a connector terminal preparation method, which enhances the conductivity, heat resistance and anti-wear and anti-rust properties of the component parts thus made so that the finished connector terminal can provide a high level of signal transmission efficiency and stability.

To achieve this and other objects of the present invention, a connector terminal preparation method comprises the step of preparing a metal socket comprising a base and a cylindrical body extended from one side of the base and defining with the base an accommodation chamber, and then making a through hole on the base of the metal socket and then dipping the metal socket in an electrolyte solution containing dissolved metal salts and ions in an electroplating machine and applying a direct current to the electrolyte solution for enabling the direct current to go through the through hole and to move evenly over inner and outer surfaces of the base and the cylindrical body of the metal socket so that dissolved metal ions in the electrolyte solution are reduced and deposited onto the metal socket to form a metal coating layer on the inner and outer surfaces of the base and cylindrical body of the metal socket, and the step of removing the metal socket from the electroplating machine and then employing a mechanical processing process to deform the base of the metal socket and to have the through hole of the metal socket be fully enclosed. When depositing the metal coating layer on the inner and outer surfaces of the base and cylindrical body of the metal socket, the structural design of the through hole enables the applied electric current to be evenly distributed over the inner and outer surfaces of the metal socket and facilitates quick dissipation of released gases during electroplating. Thus, the finished metal socket has the characteristic of low resistivity (high conductivity), enhancing signal transmission efficiency and stability.

### BRIEF DESCRIPTION OF THE DRAWINGS

FIG. 1 is an oblique elevational view of a connector terminal in accordance with the present invention.

FIG. 2 is an exploded view of the connector terminal in accordance with the present invention.

FIG. 3 corresponds to FIG. 2 when viewed from another angle.

FIG. 4 is a metal socket manufacturing flow chart in accordance with the present invention.

FIG. 5 is a sectional side view, illustrating a through hole made on the base of the metal socket in accordance with the present invention.

FIG. 6 corresponds to FIG. 5, illustrating a metal coating layer deposited onto the inner and outer surfaces of the metal socket.

FIG. 7 is a schematic sectional side view of the present invention, illustrating a part of the base of the metal socket formed into a nozzle-shaped bottom protrusion.

FIG. 8 corresponds to FIG. 7, illustrating the nozzle-shaped bottom protrusion flattened.

FIG. 9 is an elevational view of a metal socket made according to the present invention.

FIG. 10 is a schematic sectional side view of the present invention, illustrating a through hole formed on the base of the metal socket and the base kept planar.

FIG. 11 corresponds to FIG. 10, illustrating a metal coating layer electroplated onto the inner and outer surface of the base and cylindrical body of the metal socket.

FIG. 12 corresponds to FIG. 11, illustrating a recessed portion formed on the planar bottom wall of the base of the metal socket and the through hole fully enclosed.

### DETAILED DESCRIPTION OF THE PREFERRED EMBODIMENT

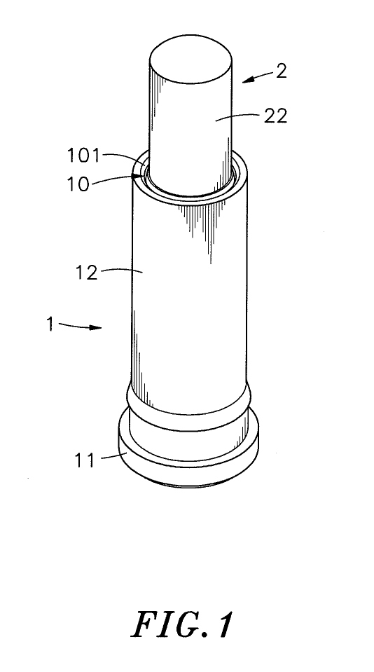

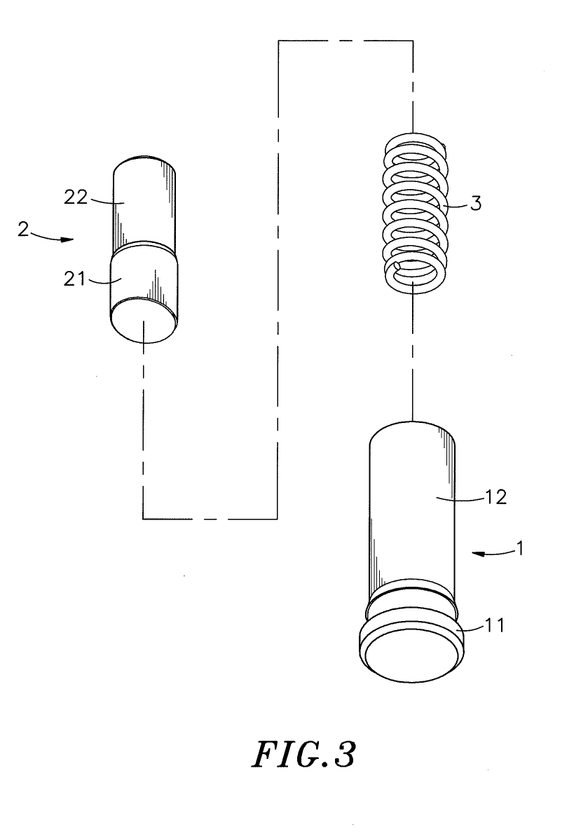

Referring to FIGS. 1-3, a connector terminal in accordance with the present invention is shown. The connector terminal comprises a metal socket 1, a probe head 2, and an elastic member 3 set between the metal socket 1 and the probe head 2.

The metal socket 1 comprises a base 11, a cylindrical body 12 perpendicularly extended from one side of the base 11, an accommodation chamber 10 surrounded by the base 11 and the cylindrical body 12 for accommodating the probe head 2 and the elastic member 3, and an opening 101 located on one end, namely, the top end of the cylindrical body 12 remote from the base 11 and disposed in communication with the accommodation chamber 10.

The probe head 2 is shaped like a stepped cylinder, comprising a lower stoppage portion 21 having a relatively larger diameter and accommodated in the accommodation chamber 10, and an upper contact portion 22 having a relatively smaller diameter and extended from the lower stoppage portion 21 out of the metal socket 1 through the opening 101. The diameter of the lower stoppage portion 21 is larger than the opening 101. The elastic member 3 has its one end stopped against the base 11 of the metal socket 1, and its other end stopped against the bottom wall of the lower stoppage portion 21 of the probe head 2. Thus, the elastic member 3 elastically deformably supports the probe head 2 in the metal socket 1.

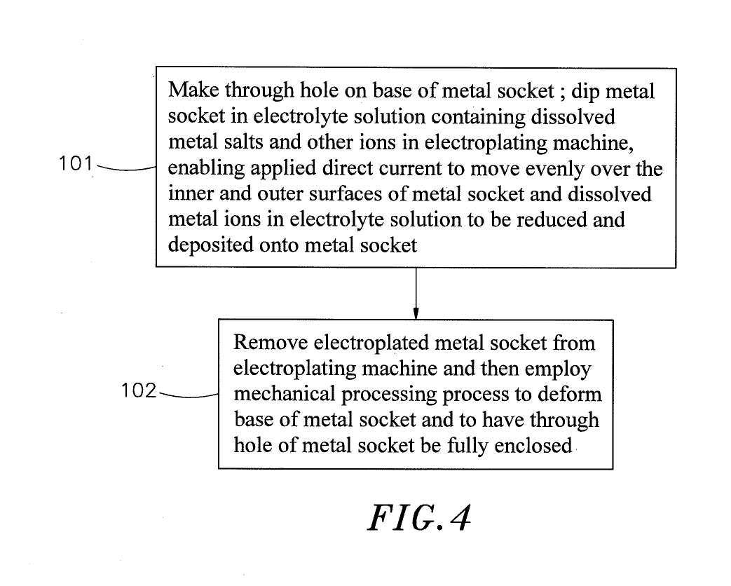

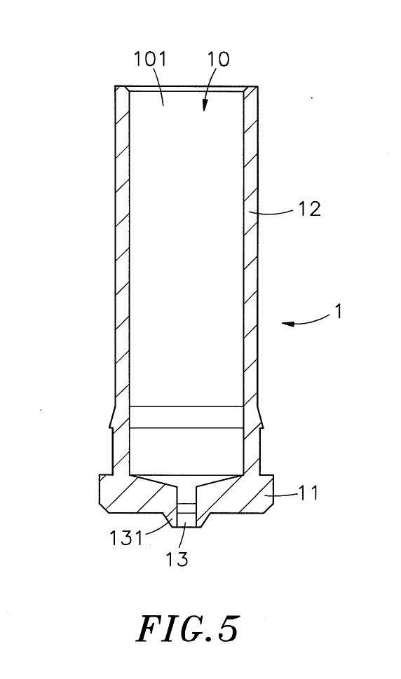

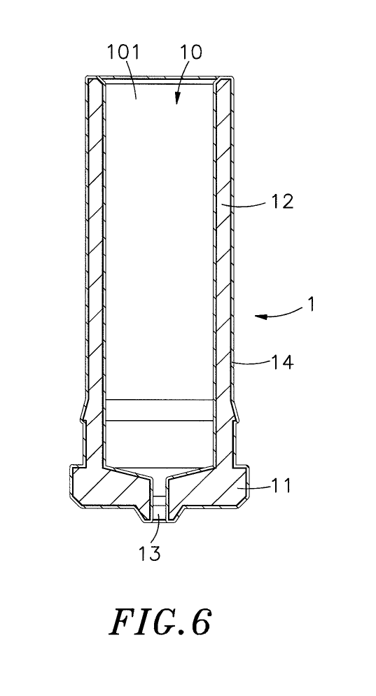

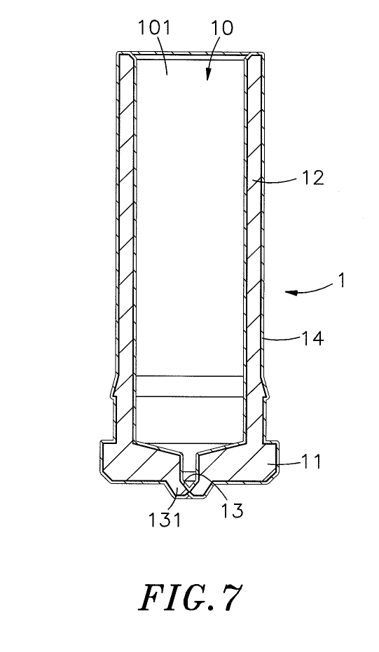

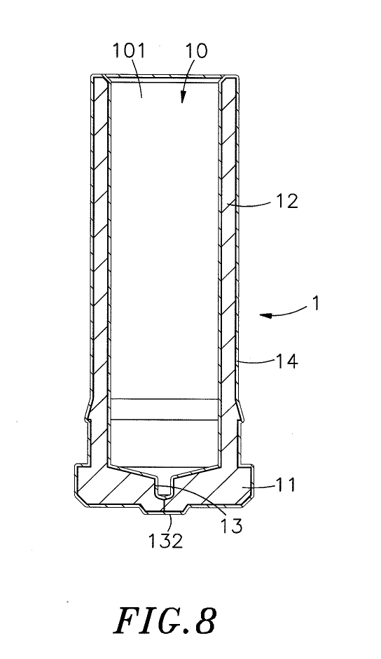

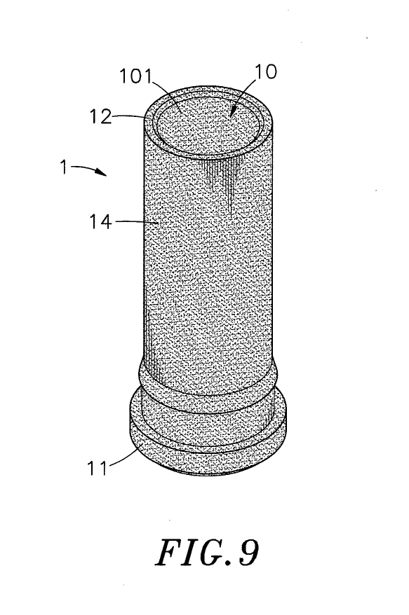

Referring to FIGS. 4-9, the preparation of the aforesaid connector terminal includes the steps of:
(101) Make a through hole 13 on the base 11 of the metal socket 1 and then dip the metal socket 1 in an electrolyte solution containing dissolved metal salts and other ions in an electroplating machine, enabling the applied direct current to go through the through hole 13 and to move evenly over the inner and outer surfaces of the metal socket 1, and thus, dissolved metal ions in the electrolyte solution are reduced at the interface between the solution and the metal socket (cathode) 1 and deposited onto the metal socket (cathode) 1, forming a metal coating layer 14 on the inner and outer surfaces of the metal socket 1.
(102) Remove the electroplated metal socket 1 from the electroplating machine and then employ a mechanical processing process to deform the base 11 of the metal socket 1 and to have the through hole 13 be fully enclosed, and thus the preparation of the connector terminal in accordance with the present invention is done.

As stated above, during the fabrication of the connector terminal, the base 11 of the metal socket 1 is processed to provide a through hole 13 in communication between the accommodation chamber 10 and the outside of the base 11 of the metal socket 1 with a drilling or milling machine, or employing any other machining techniques. At this time, a part of the base 11 around the through hole 13 is processed into a nozzle-shaped bottom protrusion 131. This through hole 13 has a diameter smaller than the inner perimeter of the elastic member 3. Thereafter, dip the metal socket 1 in an electrolyte solution containing dissolved metal salts and other ions in an electroplating machine (not shown), enabling the applied direct current to go through the through hole 13 and to move evenly over the inner and outer surfaces of the base 11 and cylindrical body 12 of the metal socket 1, and thus, dissolved metal ions in the electrolyte solution are reduced at the interface between the solution and the metal socket (cathode) 1 and deposited onto the metal socket (cathode) 1, forming the desired metal coating layer 14 on the inner and outer surfaces of the base 11 and cylindrical body 12 of the metal socket 1. During the electrodeposition of the metal coating layer 14 on the inner and outer surfaces of the base 11 and cylindrical body 12 of the metal socket 1, the structural design of the through hole 13 enables the applied electric current to be evenly distributed over the inner and outer surfaces of the base 11 and cylindrical body 12 of the metal socket 1 and facilitates quick dissipation of released gases (such as hydrogen and etc.), thereby increasing current efficiency (the ratio of the amount of electricity, in coulombs, theoretically required to yield a given quantity of material in an electrochemical process, to the amount actually consumed) and shortening the electroplating time to reach the desired coating thickness. Thus, the manufacturing cost of the connector terminal can be relatively reduced. After coated with the metal coating layer 14, the metal socket 1 has excellent conductivity, heat resistance and anti-wear and anti-rust properties. After the metal socket 1, the probe head 2, the elastic member 3 and the plug 4 are assembled, the finished connector terminal has the characteristic of low resistivity (high conductivity), enhancing signal transmission efficiency and stability.

After electrodeposition of the metal coating layer 14, take the metal socket 1 out of the electroplating machine and then employ riveting, squeezing or any other suitable mechanical processing method to deform the nozzle-shaped bottom protrusion 131 of the base 11 of the metal socket 1 and to force the nozzle-shaped bottom protrusion 131 toward the through hole 13, enabling the nozzle-shaped bottom protrusion 131 to be flattened to form a flat wall 132 that fully encloses the through hole 13. Thus, the manufacturing process is done.

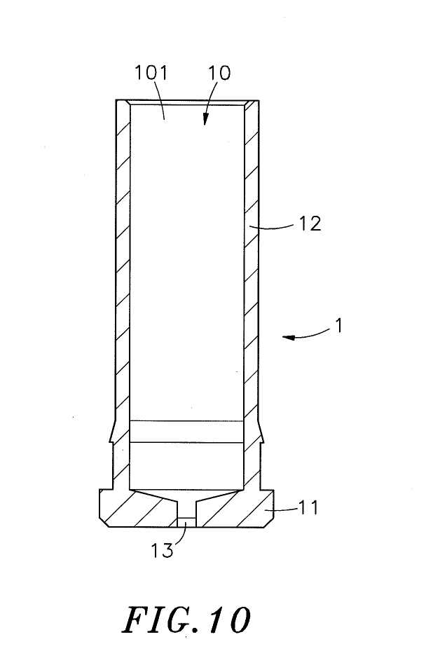

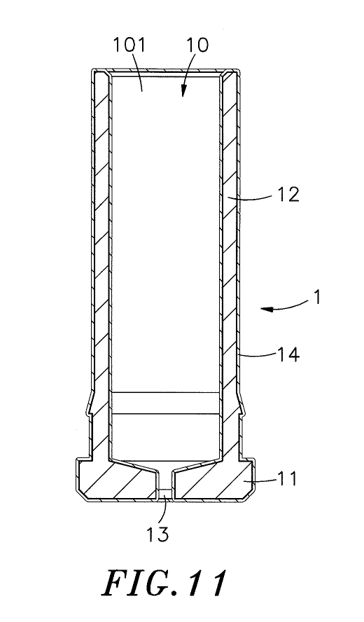

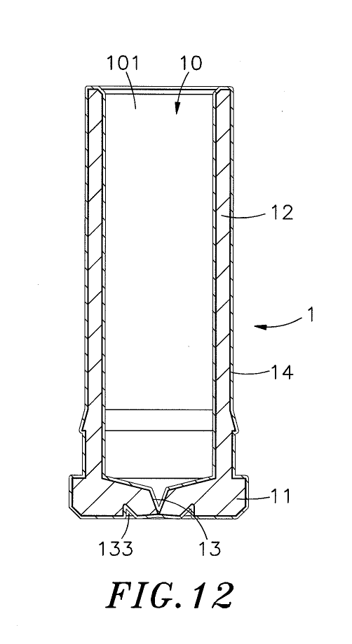

Referring to FIGS. 10, 11 and 12, in an alternate form of the present invention, the bottom wall of the base 11 of the metal socket 1 is kept planar after formation of the through hole 13. After formation of the through hole 13, the metal socket 1 is electroplated to have the desired metal coating layer 14 be deposited on the inner and outer surface of the base 11 and cylindrical body 12 of the metal socket 1. Thereafter, a mechanical processing process is employed to deform the base 11 of the metal socket 1, forming a recessed portion 133 on the bottom wall of the base 11 around the through hole 13 and having the through hole 13 be fully enclosed.

In the aforesaid processing examples, the techniques of how to deposit the desired metal coating layer 14 on the inner and outer surfaces of the base 11 and cylindrical body 12 of the metal socket 1, how to make the through hole 13 on the base 11 of the metal socket 1 and how to deform the base 11 of the metal socket 1 to have the through hole 13 be fully enclosed are of the known art, and therefore no further detailed description in this regard is necessary.

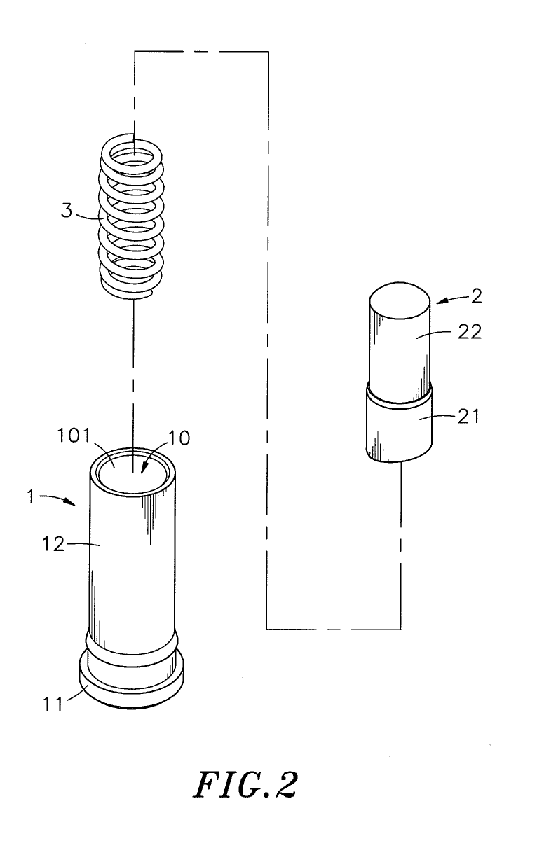

Referring to FIGS. 2, 4, 7, 8 and 9 again, the main feature of the present invention is to make a through hole 13 on the base 11 of the metal socket 1 before coating so that the applied direct current can go through the through hole 13 and move evenly over the inner and outer surfaces of the base 11 and cylindrical body 12 of the metal socket 1 during the electroplating process, and thus the desired metal coating layer 14 can be efficiently deposited on the inner and outer surfaces of the base 11 and cylindrical body 12 of the metal socket 1. After deposition of the metal coating layer 14 on the inner and outer surfaces of the base 11 and cylindrical body 12 of the metal socket 1, the base 11 of the metal socket 1 is mechanically processed to enclose the through hole 13. Thus, the finished metal socket 1 has enhanced conductivity, heat resistance and anti-wear and anti-rust properties for making a connector terminal that can provide a high level of signal transmission efficiency and stability.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A connector terminal preparation method for preparing a connector terminal comprising a metal socket, a probe head partially accommodated in said metal socket and an elastic member mounted in said metal socket to support said probe head, the connector terminal preparation method comprising the step of:
(a) preparing a metal socket raw member comprising a base and a cylindrical body extended from one side of said base and defining with said base an accommodation chamber, and then processing said metal socket raw member into a semi-finished metal socket by: making a through hole on the base of said metal socket raw member and then dipping said metal socket raw member in an electrolyte solution containing dissolved metal salts and ions in an electroplating machine and applying a direct current to said electrolyte solution for enabling said direct current to go through said through hole and to move evenly over inner and outer surfaces of said base and said cylindrical body of said metal socket raw member so that dissolved metal ions in said electrolyte solution are reduced and deposited onto said metal socket raw member to form a metal coating layer on the inner and outer surfaces of the base and cylindrical body of said metal socket raw member;
(b) removing said semi-finished metal socket thus obtained from said electroplating machine and then employing a mechanical processing process to deform the base of said semi-finished metal socket and to have the through hole of said semi-finished metal socket be fully enclosed so that a finished metal socket is obtained.

2. The connector terminal preparation method as claimed in claim 1, wherein said through hole of said semi-finished metal socket is made during step (a) using one of drilling and milling machines.

3. The connector terminal preparation method as claimed in claim 1, wherein said through hole made on said base of said semi-finished metal socket has a diameter smaller than said inner perimeter of said elastic member, and the elastic member is a spring having one end stopped against the base and the other end stopped against a bottom wall of the probe head.

4. The connector terminal preparation method as claimed in claim 1, wherein a part of the base of said semi-finished metal socket is processed into a nozzle-shaped bottom protrusion around said through hole during formation of the through hole in step (a); the base of said semi-finished metal socket is deformed to have said through hole of said semi-finished metal socket be fully enclosed during step (b) by: employing one of riveting and squeezing mechanical processing methods to deform said nozzle-shaped bottom protrusion and to force said nozzle-shaped bottom protrusion toward said through hole.

5. The connector terminal preparation method as claimed in claim 4, wherein when deforming the base of said semi-finished metal socket to enclose said through hole during step (b), said nozzle-shaped bottom protrusion is flattened to form a flat wall that fully encloses said through hole.

6. The connector terminal preparation method as claimed in claim 1, wherein the mechanical processing process employed to deform the base of said semi-finished metal socket during step (b) is to form a recessed portion on a bottom wall of said base around said through hole and to squeeze a part of said base toward said through hole to have said through hole be fully enclosed.
